(19) United States
(12) Patent Application Publication
(10) Pub. No.: US 2006/0162600 A1
(43) Pub. Date: Jul. 27, 2006

(54) Method for replacing printing sleeves in a printing press

(76) Inventors: Franz Plasswich, Bremen (DE); Frank Twiehaus, Westerkappeln (DE)

Correspondence Address: JACOBSON HOLMAN PLLC, 400 SEVENTH STREET N.W., SUITE 600, WASHINGTON, DC, 20004, US

(21) Appl. No.: 10/545,227

(22) PCT Filed: Jan. 14, 2004
(86) PCT No.: PCT/EP04/00411

§ 371 Date: Aug. 12, 2005

(30) Foreign Application Priority Data
Feb. 12, 2003 (DE) 10305956.3

(51) Int. Cl. B41F 1/34

(52) U.S. Cl. 101/485

(57) ABSTRACT

The invention relates to a process for replacing printing sleeves (7) of a printing machine (1), in which printing sleeves (7) that are not required for the actual printing process are mounted in at least one storage device and the transportation of the printing sleeves (7) necessary for the replacement between the storage device and the printing machine (1) is performed by at least one transportation device (13), that comprises printing sleeve retaining devices (14) that can bring the printing sleeves (7) into a position that is suited for the replacement of the printing sleeves (7). The present invention is characterized in that the arrangement of the printing sleeves (7) in the transportation device (13) is determined by a processing and control unit (19), to which the set positions of the printing sleeves in the printing machine during the next printing job are known. The processing and control unit (19) adjusts the arrangement of the printing sleeves (7) in such a manner that at least one printing sleeve retaining device (14) remains free in the transportation device (13).

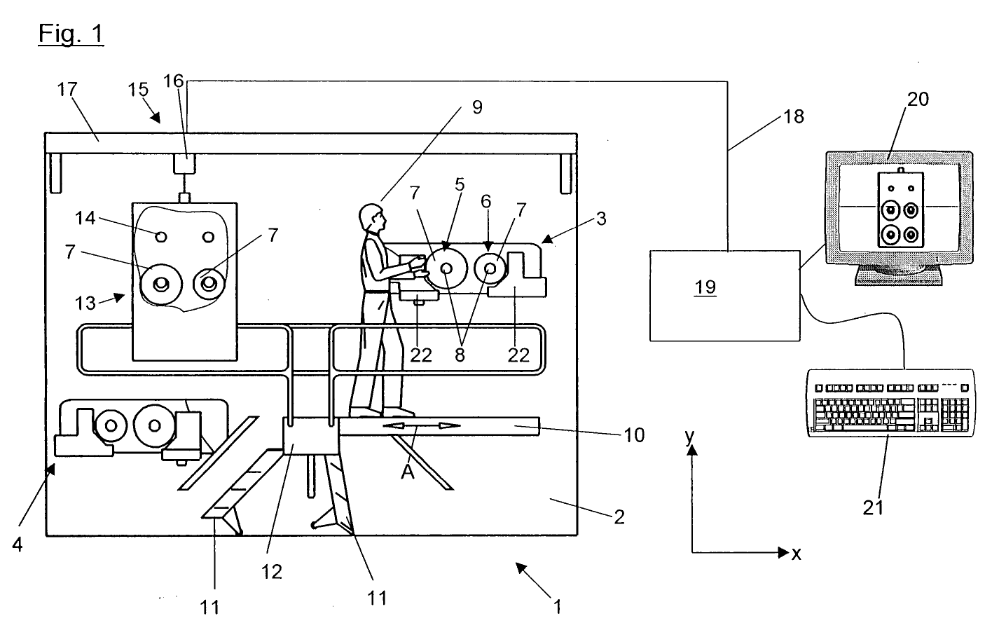

The invention relates to a process for replacing printing sleeves in a printing machine according to the generic term of claim 1.

For the processing of printing jobs it is frequently necessary to replace the printing motifs of the print rollers of a printing machine. For the purpose of being able to execute this job changeover as quickly and easily as possible, frequently only the printing sleeves carrying the printing motifs and lying on the roller mandrels are replaced.

The unpublished patent application DE 102 23 414 suggests a transportation device for printing sleeves with several carrying mandrels for accommodating the printing sleeves. Every two adjoining carrying mandrels have a distance between them that corresponds to the distance of the print roller and the anilox roller in their set-up positions. Both these carrying mandrels form one row inside the transportation device. The transportation device can be coupled to a lifting device by means of which it can move horizontally and vertically with respect to the printing machine.

If a printing sleeve is supposed to be replaced, the operating personnel must first equip the transportation device with the printing sleeves to be inserted into the printing machine. The operating personnel also has to position the transport device with the help of the lifting device in front of the printing unit in which the printing sleeves to be replaced are located, so that two free carrying mandrels are positioned in front of the print rollers. Then the printing sleeves located on the print roller mandrels can be pulled out by the operating personnel. Subsequently, the transportation device is placed in a new position in order to bring the printing sleeves into a suitable position for fitting them on the roller mandrels. Then the printing sleeves can be fitted. If necessary, the process is carried out similarly for additional printing units.

In the described process for the replacement of printing sleeves of a printing machine, the operating personnel equips the transportation device without observing any predetermined arrangement of the printing sleeves. Thus the operating personnel must independently plan the arrangement of the printing sleeves in the transportation device. This arrangement is in part disadvantageous for the set-up process. Additionally, it also entails the risk of an erroneous allocation of the printing sleeves to the roller mandrels.

Therefore the task of the present invention is to suggest a process for replacing printing sleeves in printing machines that simplifies the process of replacement of printing sleeves.

According to the invention, this task is solved by the features specified in the characteristics of claim 1.

According to it, the arrangement of the printing sleeves in the transportation device is determined by a processing and control unit. In doing so, the arrangement of the printing sleeves is adjusted in such a manner that at least one printing sleeve retaining device in the transportation device remains free. The processing and control unit takes into account all the relevant printing sleeves. Thus not only those that are supposed to be supplied to the printing machine are taken into account but also those that have to be led away from the printing machine and supplied to the storage device. As a basis for the determination of the arrangement of the printing sleeves, the processing and control unit uses data about the set positions of the individual printing sleeves for processing the new printing job as well as data about the actual positions of the printing sleeves in the printing machine. Even data about the positions of the printing sleeves in the storage device can be known to the processing and control unit.

Advantageously the process and control unit determines the arrangement of the printing sleeves in the transportation device in such a manner that every row contains at least one empty printing sleeve retaining device and at least one new printing sleeve required for the new printing job. Each row of the transportation device is thus assigned to a definite printing unit. Thus for each printing unit at least one empty printing sleeve retaining unit is provided. If for instance, the printing unit is arranged horizontally, the printing sleeve retaining devices can also be arranged horizontally. In this case, after a printing sleeve of a processed printing job is pushed off, only the transportation device must be displaced horizontally in order to reach a position in which a new printing sleeve can be fitted on the roller mandrel.

In another preferred embodiment of the invention, the processing and control unit determines the arrangement of the printing sleeves in the transportation device in such a manner that one row of printing sleeve retaining devices remains free and the other rows contain the printing sleeves assigned to the respective printing units. In this case thus firstly all printing sleeves of a printing unit are removed by the roller mandrels. Thereafter, the transportation device is displaced vertically so that the new printing sleeves assigned to the related printing unit can be brought into a position that is suitable for the replacement.

It is particularly advantageous if the arrangement of the printing sleeves in the transportation-device determined by the processing and control unit is indicated on a display unit. A monitor can be provided as a display unit. However, even other means for indicating the arrangement are suitable for this purpose, for instance, printouts from a printer.

In a preferred embodiment of the invention, the arrangement of the printing sleeves in the transportation device determined by the processing and control unit is executed by the operating personnel. For this purpose the operating personnel removes the corresponding printing sleeves from the storage device and arranges them in the transportation device according to the arrangement indicated on the display unit.

It is particularly advantageous if the processing and control unit has interfaces to actuators of the storage and/or transportation device and controls them in such a manner that they carry out the transfer, at least in part, between the two said devices. For this purpose, the processing and control unit has access to data that contains the positions of every individual printing sleeve in the storage device. In this manner the transportation device can be equipped with printing sleeves without permutation. The printing sleeves that are removed from the printing machine and transported in the transport device are supplied in the similar manner to the storage device, wherein the data containing the positions of the printing sleeves remain accessible for the processing and control unit. A data memory connected to the processing and control unit can be used for this purpose.

Furthermore, it is advantageous if the processing and control unit has interfaces to actuators of the transportation device and/or the printing machine and controls them in such a manner that they execute at least in part the transfer between the two said devices. A control of this type serves for the automatic transfer of the transportation device to the printing machine and back. Moreover, the control can comprise the coupling and decoupling of the transportation-device to and/or from a lifting device as well as the movement of the transportation device with respect to the printing machine.

In a preferred embodiment of the invention, the processing and control unit, on the basis of the arrangement of the printing sleeves in the transportation device determined by it, controls the position of the transportation device with respect to the printing machine in such a manner that empty printing sleeve retaining devices are brought into a removal position to the roller mandrels that are loaded with the printing sleeves to be replaced and subsequently the printing sleeve retaining devices loaded with the new printing sleeves are brought into the replacement position. In this course of action, the operating personnel can first remove a printing sleeve of the already processed printing job from the roller mandrel and fit it on an empty printing sleeve retaining device. If the operating personnel of the processing and control unit has indicated the completion of this activity, for instance, by means of a key press, then the processing and control unit controls the actuators in such a manner that the printing sleeve of the new printing job that is supposed to be fitted on the roller mandrel is brought into the replacement position. This process is carried out for all roller mandrels from which a printing sleeve is supposed to be removed and/or on which a printing sleeve is supposed to be fitted.

The single FIGURE illustrates a printing machine that is set up as per the process according to the invention.

The printing machine 1 comprises two side frames of which the front side frame 2 can be seen in the FIGURE. From the front side frame 2, several printing units are accessible of which two printing units 3, 4 are illustrated as an example. From the printing unit 3, both the bearing blocks 22 can be seen located in their distant positions so that the print roller 5 and the anilox roller 6 are accessible. The print roller 5 comprises substantially of the roller mandrel 8 and the printing sleeve 7 fitted on it. The anilox roller 6 is set up similarly.

In order to reach the lower printing units, of which only the printing unit 4 is illustrated, the footbridge 10 that is mounted in the pedestal 12 can be displaced along the arrow A. Moreover any of the two staircases 11 can be folded.

Furthermore, the printing machine comprises a lifting device 15 with which a transportation device 13 can move with respect to the printing machine 1. A horizontal movement is possible due to a slide rail 17 that is attached to the side frame 2. A rope winch 16 that is mounted displaceably on the slide rail 17, serves for lifting the transport device 13.

For setting up the printing machine 1 for a new printing job, the operating personnel can first give information about the new printing job to the processing and control unit 19 via a keyboard 21. Subsequently the processing and control unit computes the arrangement of the printing sleeves in the transportation device 13. Now the operating personnel 9 must equip the transportation device 13 in a manner that is not illustrated in closer detail according to the arrangement determined by the processing and control unit 19. For this purpose this arrangement is displayed on the monitor 20. Subsequently, the operating personnel 9 goes to the first printing unit 3 from which the printing sleeves 7 have to be removed. The processing and control unit 19 controls the lifting device 15 via the control line 18 in such a manner that a free carrying mandrel 14 of the transportation device 13 is brought into a position that makes it possible to pull out a printing sleeve 7 from the roller mandrel 8. After the displacement of the printing sleeve 7 from the roller mandrel 8 onto the carrying mandrel 14, the operating personnel 9 activates a pushbutton that is not illustrated in the FIGURE. The processing and control unit 19 now controls the lifting device 15 so that a carrying mandrel 14 on which a new printing sleeve 7 is present, takes up a replacement position. After the displacement of this printing sleeve 7, the operating personnel 9 reactivate the pushbutton that is not illustrated in the FIGURE.

The described course of action is carried out for all additional print and/or anilox rollers 5, 6 that have to be equipped for the new printing job.

List of reference symbols

| | |
|---|---|
| 1 | Printing machine |
| 2 | Side frame |
| 3 | Printing unit |
| 4 | Printing unit |
| 5 | Print roller |
| 6 | Anilox roller |
| 7 | Printing sleeve |
| 8 | Roller mandrel |
| 9 | Operating personnel |
| 10 | Footbridge |
| 11 | Staircase |
| 12 | Pedestal |
| 13 | Transportation device (conveyor) |
| 14 | support mandrel |
| 15 | Lifting device |
| 16 | Rope winch |
| 17 | Slide rail |
| 18 | Control line |
| 19 | Processing and control unit |
| 20 | Monitor |
| 21 | Keyboard |
| 22 | Bearing block |
| 23 | |
| 24 | |
| A | displacement direction of the footbridge 10 |
| x, y | Moving directions of the lifting device 15 |

1. Process for changing printing sleeves (7) of a printing machine (1), in which printing sleeves (7) that are not required for the actual printing process,
are mounted in at least one storage device and
the transportation of the printing sleeves (7) necessary for the replacement between the storage device and the printing machine (1) is performed by at least one transportation device (13), that comprises printing sleeve retaining devices (14) that can bring the printing sleeves (7) into a position that is suited for the replacement of the printing sleeves (7) characterized in that
the arrangement of the printing sleeves (7) in the transportation device (13) is determined by a processing and control unit (19),
to which the set positions of the printing sleeves in the printing machine during the next printing job are known, and that (19) adjusts the arrangement of the printing sleeves (7) in such a manner that at least one printing sleeve retaining device (14) remains free in the transportation device (13).

2. Process according to claim 1 characterized in that the processing and control unit (19) determines the arrangement of the printing sleeves (7) in the transportation device (13) in such a manner that every row contains at least one empty printing sleeve retaining device (14) and at least one new printing sleeve (7) required for the new printing job.

3. Process according to claim 1 characterized in that the processing and control unit (19) determines the arrangement of the printing sleeves (7) in the transportation device (13) in such a manner that one row remains free of printing sleeve retaining devices (14) and the other rows contain the printing sleeves (7) assigned to the respective printing units (3, 4).

4. Process according to claim 1 characterized in that the arrangement of the printing sleeves (7) in the transportation device (13) determined by the processing and control unit (19) is indicated on a display unit (20).

5. Process according to claim 1 characterized in that the arrangement of the printing sleeves (7) in the transportation device (13) determined by the processing and control unit (19) is carried out by the operating personnel (9).

6. Process according to claim 1 characterized in that the processing and control unit (19) has interfaces for actuators of the storage and/or transportation device (13) and controls them in such a manner that they execute, at least in part, the transfer between the two said devices.

7. Process according to claim 1 characterized in that the processing and control unit (19) has interfaces for actuators of the storage and/or transportation device (13) and/or the printing machine (1) and controls them in such a manner that they execute, at least in part, the transfer between the two said devices.

8. Process according to claim 1 characterized in that the processing and control unit (19), on the basis of the arrangement of the printing sleeves (7) in the transportation device (13) determined by it, controls the position of the printing sleeves accommodation devices (14) in the transportation device (13) in such a manner that empty printing sleeve retaining devices (14) are brought into a removal position to the roller mandrels (8) that are loaded with the printing sleeves (7) to be replaced and subsequently the printing sleeve retaining devices (14) loaded with the new printing sleeves (7) are brought into the replacement position.

9. Device for the replacement of printing sleeves (7) in a printing machine (1) in which the printing sleeves (7) that are not required for the actual printing process,
can be mounted in at least one storage device and
the transportation of the printing sleeves (7) necessary for the replacement between the storage device and the printing machine (1) is performed by at least one transportation device (13), that comprises printing sleeve retaining devices (14) that can bring the printing sleeves (7) into a position that is suited for the replacement of the printing sleeves (7) and can adjust the arrangement of the printing sleeves (7) in such a manner that at least one printing sleeve retaining device (14) remains free in the transportation device (13), characterized in a processing and control unit (19) that can determine the arrangement of the printing sleeves (7) in the transportation device (13).

10. Device according to claim 9 characterized in that the arrangement of the printing sleeves (7) in the transportation device (13) determined by the processing and control unit (13) can be indicated on a display unit (20).
